(19) United States
(12) Patent Application Publication
(10) Pub. No.: US 2024/0163665 A1
(43) Pub. Date: May 16, 2024

(54) METHOD AND SYSTEM FOR PERFORMING A NETWORK SLICE SPECIFIC AUTHENTICATION AUTHORIZATION PROCEDURE FOR A NETWORK SLICE

(71) Applicant: Samsung Electronics Co., Ltd., Suwon-si, Gyeonggi-do (KR)

(72) Inventors: Ashok Kumar NAYAK, Bangalore (IN); Rajavelsamy RAJADURAI, Bangalore (IN); Varini GUPTA, Bangalore (IN); Hoyeon LEE, Suwon-si (KR)

(21) Appl. No.: 18/282,430

(22) PCT Filed: Mar. 17, 2022
(86) PCT No.: PCT/KR2022/003722

§ 371 Date: Sep. 15, 2023

(30) Foreign Application Priority Data
Mar. 17, 2021 (IN) 202141011382
Jan. 13, 2022 (IN) 202141011382

(51) Int. Cl. H04W 12/06; H04L 9/40; H04W 12/088

(52) U.S. Cl. CPC H04W 12/06; H04L 63/0892; H04W 12/088

(57) ABSTRACT

A method for performing a Network Slice Specific Authentication Authorization (NSSAA) procedure for a network slice is disclosed. The method includes performing, by a Network Slice Specific Authentication and Authorization Function (NSSAAF), an NSSAA procedure through a first Access and Mobility Management Function (AMF) selected amongst the first AMF and a second AMF. The method includes determining, by the NSSAAF whether the NS SAA procedure through the first AMF is successful or not. The method includes performing by the NSSAAF, one of skipping the NSSAA procedure for the second AMF in response to determining that the NSSAA procedure is successful for the first AMF transmitting a message to the second AMF for deleting Network Slice Selection Assistance Information (NSSAI) related to the network slice from an allowed list of network slices in response to determining that the NSSAA procedure is unsuccessful for the first AMF.

### TECHNICAL FIELD

The present disclosure generally relates to field of network and communication, and more particularly to a method and a system for network slice-specific authentication & authorization when a User Equipment (UE) is served by two Access and Mobility Management Functions (AMFs).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

[8] Network slicing has been introduced by 5G defined by 3GPP specification. Operators can create thousands of virtual and independent networks which will cater to all kind of requirements or services. After successful registration by UE it is not necessary that one particular slice will be allowed for use. Operator may configure and mark some slices for authentication and authorization purpose before it allows for UE to use it. The same is mentioned as part of NSAAA procedure in TS 23.502.

[9] Specifically, TS 23.502 Sec 4.2.9 has detailed steps for NSSAA (network slice-specific authentication & authorization) procedure. Most of the times UE is served by same AMF even if it is registered over 3GPP & N3GPP access. Hence, with respect to AAA-S triggered re-authentication & revocation, same AMF get request from NSSAAF and based on the network policy, AMF executes the operation over one access or both the access.

However, existing standard does not mentioned about the NSSAA procedure when UE is served by two different AMFs. It happens when UE is registered over one access with HPLMN & other access with VPLMN. Also because of EPC interworking scenario, UE may be served by two different AMFs over different access as part of same PLMN.

More specifically, the prevailing standard is not yet clear and defines the procedure if the UE is served by two different AMFs which may occur if both AMFs belong to different PLMN or because of EPC interworking where both AMFs will serve the UE as part of same PLMN.

Thus, there is a need for a solution that overcomes the above deficiencies.

### Solution to Problem

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

In accordance with some example embodiments of the present disclosure, a method for performing a Network Slice Specific Authentication Authorization (NSSAA) procedure for a network slice is disclosed. The method includes performing, by a Network Slice Specific Authentication and Authorization Function (NSSAAF), an NSSAA procedure through a first Access and Mobility Management Function (AMF) selected amongst the first AMF and a second AMF. The method includes determining, by the NSSAAF whether the NSSAA procedure through the first AMF is successful or not. The method includes performing by the NSSAAF, one of, skipping the NSSAA procedure for the second AMF in response to determining that the NSSAA procedure is successful for the first AMF, or, transmitting a message to the second AMF for deleting Network Slice Selection Assistance Information (NSSAI) related to the network slice from an allowed list of network slices in response to determining that the NSSAA procedure is unsuccessful for the first AMF.

In accordance with some example embodiments of the present disclosure, a system for performing a Network Slice Specific Authentication Authorization (NSSAA) procedure for a network slice is disclosed. The system includes performing, by a Network Slice Specific Authentication and Authorization Function (NSSAAF), an NSSAA procedure through a first Access and Mobility Management Function (AMF) selected amongst the first AMF and a second AMF. The system includes determining, by the NSSAAF whether the NSSAA procedure through the first AMF is successful or not. The system includes performing by the NSSAAF, one of, skipping the NSSAA procedure for the second AMF in response to determining that the NSSAA procedure is successful for the first AMF, or, transmitting a message to the second AMF for deleting Network Slice Selection Assistance Information (NSSAI) related to the network slice from an allowed list of network slices in response to determining that the NSSAA procedure is unsuccessful for the first AMF.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### Advantageous Effects of Invention

According to an embodiment of the disclosure, the NSSAA procedure can be performed when UE is served by two different AMFs.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic block diagram depicting a method for performing a NSSAA procedure for a network slice, in accordance with an embodiment of the present disclosure;

FIG. 2 illustrates a schematic block diagram of a system for performing a NSSAA procedure for a network slice, in accordance with an embodiment of the present disclosure; and

FIG. 3 illustrates an operational flow diagram depicting a process for performing a NSSAA procedure for a network slice, in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### MODE FOR THE INVENTION

For promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises. a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

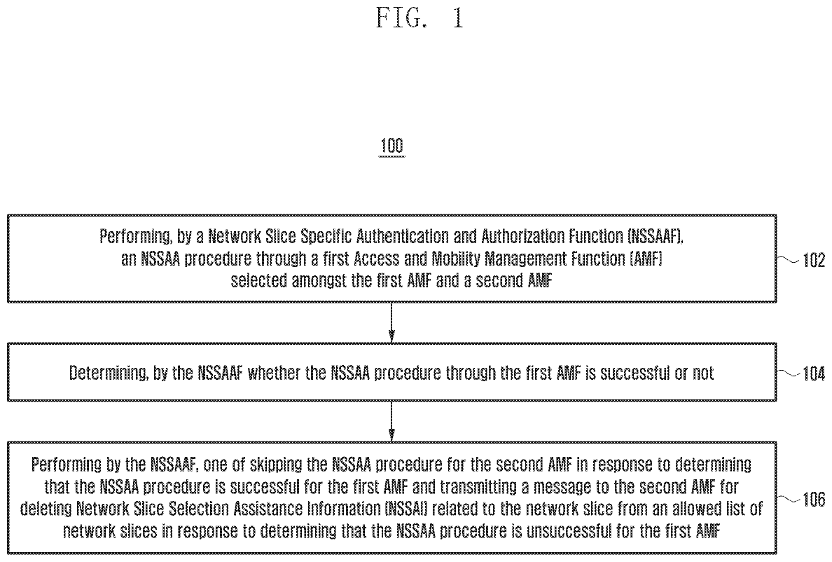

FIG. 1 illustrates a schematic block diagram 100 depicting a method for performing a NSSAA procedure for a network slice, in accordance with an embodiment of the present disclosure.

In an embodiment, the NSSAA procedure may be performed in an embodiment where a User Equipment (UE) may be served by two Access and Mobility Functions (AMFs). In an embodiment, the NSSAA may be triggered for Single—Network Slice Selection Assistance Information (S-NSSAI). The S-NSSAI may be a subject to the NSSAA based on subscription information associated with the UE. The NSSAA may be triggered by an AMF playing a role of an EAF authenticator and may communicate with an AAA-S via NSSAAF. NSSAAF does the AAA protocol interworking with AAA protocol supported by AAA-S. These procedures may be further referred in TS 23.502 and TS 33.501

In an embodiment, the UE may be registered with two AMFs belonging to two different Public Land Mobile Network (PLMN) such as one AMF for a 3GPP access and another AMF for a N3GPP access. Also, due to an Evolved Packet Core (EPC) interworking, the UE may be served by two different AMF where the two AMF may belong to a same PLMN such as one AMF for the 3GPP access and another AMF for the N3GPP access. In an embodiment, when the AAA-S may trigger a re-authentication and send a request to the NSSAAF with a Generic Public Subscription Identifier (GPSI) & S-NSSAI, the NSSAAF may receive the two different AMF addresses from a UDM leading the two AMFs to get the request from the NSSAAF 214 and execute the NSSAA procedure. This results to resource consuming and duplicating the procedure because of EAP message exchange between UE & AAA-S via both the AMF & NSSAAF.

At block 102, the method includes, performing, by a Network Slice Specific Authentication and Authorization Function (NSSAAF), an NSSAA procedure through a first Access and Mobility Management Function (AMF) selected amongst the first AMF and a second AMF.

At block 104, the method includes, determining, by the NSSAAF whether the NSSAA procedure through the first AMF is successful or not.

At block 106, the method includes, performing by the NSSAAF, one of, skipping the NSSAA procedure for the second AMF in response to determining that the NSSAA procedure is successful for the first AMF, or, transmitting a message to the second AMF for deleting Network Slice Selection Assistance Information (NSSAI) related to the network slice from an allowed list of network slices in response to determining that the NSSAA procedure is unsuccessful for the first AMF.

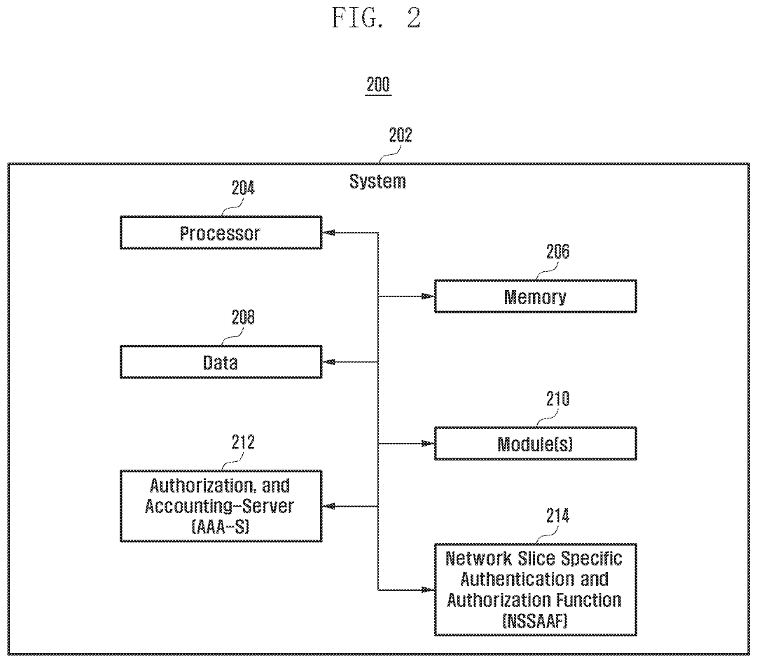

FIG. 2 illustrates a schematic block diagram 200 of a system 202 for performing a NSSAA procedure for a network slice, in accordance with an embodiment of the present disclosure.

In an embodiment, the NSSAA procedure may be performed in an embodiment where a User Equipment (UE) may be served by two Access and Mobility Functions (AMFs). In an embodiment, the NSSAA may be triggered for Single—Network Slice Selection Assistance Information (S-NSSAI). The S-NSSAI may be a subject to the NSSAA based on subscription information associated with the UE. The NSSAA may be triggered by an AMF playing a role of an EAP authenticator and may communicate with the system 202. In an embodiment, the system 202 may be configured to perform an AAA protocol interworking with an AAA protocol. These procedures may be further referred in 3GPP TS 23.502 and TS 33.501.

Continuing with the above embodiment, the system 202 may include a processor 204, a memory 206, data 208, module(s) 210, a resource(s) 212, an Authentication, Authorization, and Accounting-Server (AAA-S) 212, and an NSSAAF 214. In an embodiment, the processor 204, the memory 206, the data 208, the module(s) 210, the AAA-S 212 and the NSSAAF 214 may be communicably coupled to one another.

As would be appreciated, the system 202, may be understood as one or more of a hardware, a software, a logic-based program, a configurable hardware, and the like. In an example, the processor 204 may be a single processing unit or a number of units, all of which could include multiple computing units. The processor may be implemented as one or more microprocessors, microcomputers, microcontrollers, digital signal processors, central processing units, processor cores, multi-core processors, multi-processors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data 208 stored in the memory 206.

In an example, the memory 206 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 206 may include the data 208.

The data 208 serves, amongst other things, as a repository for storing data processed, received, and generated by one or more of, the processor 204, the memory 206, the module(s) 210, the AAA-s 212, and the NSSAAF 214.

The module(s) 210, amongst other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, instructions executed by at least one processing unit, for e.g., processor 204, or by a combination thereof. The processing unit may be a general-purpose processor which executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In some example embodiments, the module(s) 210 may be machine-readable instructions (software) which, when executed by a processor/processing unit, perform any of the described functionalities.

Continuing with the above embodiment, the AAA-S 212 may be configured to trigger the NSSAA procedure when the UE may be served by a number of Access and Mobility Management Function (AMFs). In an embodiment, the number of AMFs may include a first AMF and a second AMF. In an embodiment, the AAA-S 212 may trigger the NSSAA procedure by sharing the NSSAI related to the network slice with the NSSAAF 214.

Subsequent to being triggered by the AAA-S 212, the NSSAAF 214 may be configured to perform the NSSAA procedure through the first Access and Mobility Management Function (AMF). In an embodiment, the first AMF may be selected by the NSSAAF 214 amongst the first AMF and the second AMF. In an embodiment, the first AMF may be a 3rd Generation Partnership Project (3GPP) AMF and the second AMF may be a Non-3rd Generation Partnership Project (N3GPP) AMF.

In an embodiment, the NSSAAF 214 may be configured to select the first AMF by determining a presence of a slice context (“SliceAuthContext”) at the NSSAAF 214. In an embodiment, the “SliceAuthContext” may include addresses of the first AMF and the second AMF. Furthermore, upon determining the presence of the addresses, the NSSAAF 214 may be configured to check the NSSAI associated with the network slice and a UE Identification (ID) received from the AAA-S 212. In response to checking, the NSSAAF 214 may be configured to fetch the address of the first AMF from the “SliceAuthContext” based on the NSSAI and the UE ID. Upon fetching the address, the NSSAAF 214 may be configured to select the first AMF amongst the first AMF and the second AMF in response to fetching the address of the first AMF.

In an embodiment, where it is determined that the “SliceAuthContext” is absent at the NSSAAF 214, the NSSAAF 214 may be configured to request an Unified Data Management (UDM) to share the addresses of the first AMF and the second AMF. Furthermore, the NSSAAF 214 may be configured to select the first AMF from amongst the first AMF and the second AMF in response to receiving the addresses of the first AMF and the second AMF from the UDM.

Furthermore, the NSSAAF 214 may be configured to determine whether the NSSAA procedure for the first AMF is successful or not. In an embodiment, where it is determined that the NSSAA procedure is successful for the first AMF, the NSSAAF 214 may be configured to skip the NSSAA procedure for the second AMF. Subsequently, in an embodiment, where it is determined that the NSSAA procedure is not successful for the first AMF, the NSSAAF 214 may be configured to transmit a message to the second AMF for deleting Network Slice Selection Assistance Information (NSSAI) related to the network slice from an allowed list of network slice.

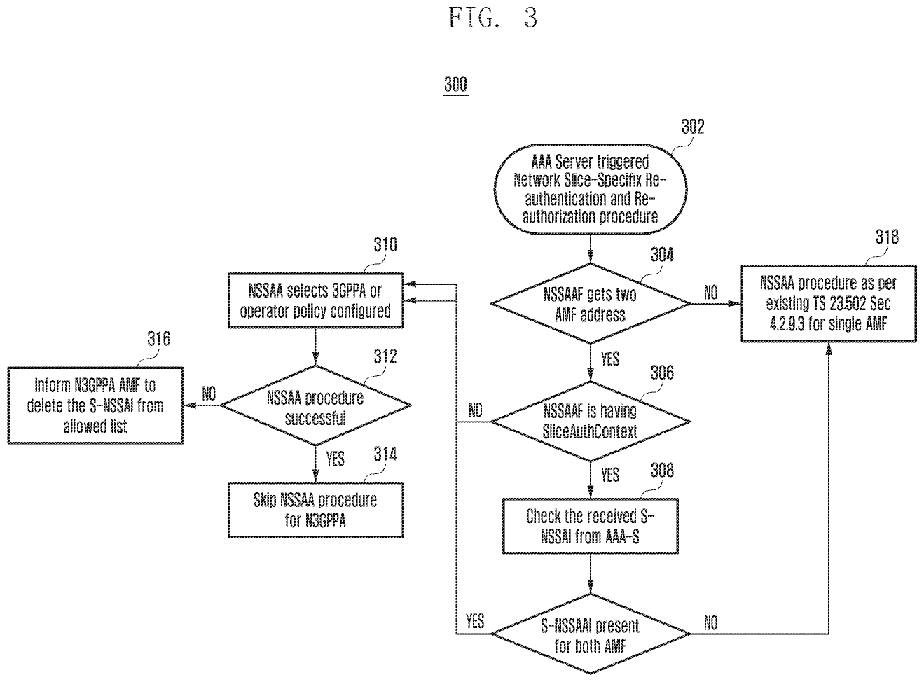

FIG. 3 illustrates an operational flow diagram 300 depicting a process for performing a NSSAA procedure for a network slice, in accordance with an embodiment of the present disclosure.

In an embodiment, the NSSAA procedure may be performed in an embodiment where a User Equipment (UE) may be served by a number of AMFs. In an embodiment, the number of AMFs may be a first AMF and a second AMF. In an embodiment, the first AMF may be a 3GPP AMF and the second AMF may be a N3GPP AMF. In an embodiment, the NSSAA may be triggered for S-NSSAI. The S-NSSAI may be a subject to the NSSAA based on subscription information associated with the UE. The NSSAA may be triggered by an AMF playing a role of an EAF authenticator and may be communicating with the AAA-S 212 via the NSSAAF 214. In an embodiment, the NSSAAF 214 may be configured to perform an AAA protocol interworking with an AAA protocol supported by the AAA-S 212. These procedures may be further referred in TS 23.502 and TS 33.501.

Continuing with the above embodiment, the process may include triggering (step 302) by the AAA-S 212, the NSSAA procedure. In an embodiment, a UDM may be configured to store AMF information such as an AMF ID, and an AMF address serving the UE and a corresponding access type such as a 3GPP access or a N3GPP access.

Furthermore, the process may include receiving (step 304) by the NSSAAF 214 the AMF information related to the first AMF and the second AMF and the corresponding access type such as one for the 3GPP access and second for the N3GPP access. As a result, the NSSAAF 214 may get Allowed NSSAI for each AMF amongst the first AMF and the second AMF. In an embodiment, if it is determined that the NSSAAF 214 is not receiving the AMF information associated with the first AMF and the second AMF, the NSAA procedure as per existing standards such as a TS 23.502 Sec 4.2.9.3 for a single AMF may be performed.

Moving forward, the process may proceed towards determining (step 306) whether the NSSAAF 214 includes a slice authentication context or not. In an embodiment, where it is determined that the NSSAAF 214 includes the slice authentication context, the process may proceed towards step 308. In an embodiment, where it is determined that the slice authentication context is absent from the NSSAAF 214, the process may proceed towards step 312.

Continuing with the above embodiment, the process may include checking (step 308) the S-NSSAI received from the AAA-S 212 by the NSSAAF 214. Further, the process may include finding a matching AMF based on the information from the UDM amongst the first AMF and the second AMF by the NSSAAF 214. In an embodiment, where it is determined that the S-NSSAI is not present for the first AMF and the second AMF, the NSAA procedure as per existing standards such as a TS 23.502 Sec 4.2.9.3 for a single AMF may be performed. In an embodiment, where it is determined the S-NSSAI is present for the first AMF and the second AMF, the process may proceed towards step 310.

Subsequently, the process may proceed towards, selecting (step 310) by the NSSAAF 214 the one access type amongst the 3GPP access, or an operator configured policy such as a N3GPP access to execute the NSSAA procedure. In an embodiment, the 3GPP access may be associated with the first AMF and the N3GPP access may be associated with the second AMF. In an embodiment, the UE may be in an idle mode for the N3GPP access and hence the second AMF may not execute the NSSA procedure and the network slice S-NSSAI may be kept in a pending list. To that understanding, the first AMF may be preferred for executing the NSSAA procedure. Further, the NSSAA procedure may be executed by the first AMF by the NSSAAF 214.

Moving forward, upon execution, the process may include determining (step 312), by the NSSAAF 214 whether the NSSAA procedure through the first AMF is successful or not. In an embodiment, where it is determined that the NSSAA procedure through the first AMF is successful, the process may proceed towards step 314. In an embodiment, where it is determined that the NSSAA procedure through the first AMF is not successful, the process may proceed towards step 316.

Subsequently, the process may proceed towards skipping (step 314) by the NSSAAF 214, the NSSAA procedure for the second AMF in response to determining that the NSSAA procedure is successful for the first AMF.

Continuing with the above embodiment, the process may include transmitting (step 316) by the NSSAAF 214, a message to the second AMF for deleting Network Slice Selection Assistance Information (NSSAI) related to the network slice from an allowed list of network slices in response to determining that the NSSAA procedure is unsuccessful for the first AMF. In an embodiment, at a point of time, the second AMF may perform a “UE Configuration Update” procedure to inform the UE that the corresponding S-NSSAI is moved to Rejected-NSSAI over the N3GPP access.

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alter-natively, certain elements may be split into multiple functional elements. Elements from one embodiment may be added to another embodiment.

1. A method performed by a network slice specific authentication and authorization function (NSSAAF), the method comprising:
performing a network slice specific authentication and authorization NSSAA procedure associated with a network slice through a first access and mobility management function (AMF) selected amongst the first AMF and a second AMF;
identifying whether the NSSAA procedure through the first AMF is successful or not; and
performing one of:
skipping a NSSAA procedure through the second AMF as a response to determining that the NSSAA procedure through the first AMF is successful; and
transmitting, to the second AMF, a message for deleting network slice selection assistance information (NSSAI) related to the network slice from an allowed list of network slices as a response to determining that the NS SAA procedure through the first AMF is unsuccessful for the first AMF.

2. The method of claim 1, further comprising:
receiving, from an authentication, authorization, and accounting-server (AAA-S), a request message including a generic public subscription identifier (GPSI) and single—network slice selection assistance information (S-NSSAI),
wherein the NSSAA procedure through the first AMF is triggered by the AAA-S.

3. The method of claim 1, wherein the first AMF is selected based on:
determining a presence of a slice context (“SliceAuthContext”) at the NSSAAF, wherein the “SliceAuthContext” comprises addresses of the first AMF and the second AMF;
checking the NSSAI associated with the network slice and a UE Identification (ID) received from an Authentication, Authorization, and Accounting-Server (AAA-S) upon determining that the NSSAAF includes the “SliceAuthContext”;
fetching the address of the first AMF from the “SliceAuthContext” based on the NS SAI and the UE ID; and
selecting the first AMF amongst the first AMF and the second AMF in response to fetching the address of the first AMF.

4. The method of claim 3, further comprising:
determining an absence of a “SliceAuthContext” at the NSSAAF;
requesting, an Unified Data Management (UDM) to share the addresses of the first AMF and the second AMF; and
selecting the first AMF from amongst the first AMF and the second AMF in response to receiving the addresses of the first AMF and the second AMF from the UDM.

5. The method of claim 1, wherein the first AMF is a 3rd generation partnership project (3GPP) AMF and the second AMF is non-3GPP N3GPP AMF.

6. A system comprising:
a processor configured to execute computer-readable instructions; and
a network slice specific authentication and authorization function (NSSAAF) configured to;
perform a network slice specific authentication and authorization NSSAA procedure associated with a network slice through a first access and mobility management function (AMF) selected amongst the first AMF and a second AMF;
identify whether the NSSAA procedure through the first AMF is successful or not; and
perform one of:
skipping a NSSAA procedure through the second AMF as a response to determining that the NSSAA procedure through the first AMF is successful; and
transmitting, to the second AMF, a message for deleting network slice selection assistance information (NSSAI) related to the network slice from an allowed list of network slices as a response to determining that the NSSAA procedure through the first AMF is unsuccessful.

7. The system of claim 6,
wherein the NSSAAF is further configured to receive, from an authentication, authorization, and accounting-server (AAA-S), a request message including a generic Public subscription identifier (GPSI) and single—network slice selection assistance information (S-NSSAI), and
wherein the NSSAA procedure through the first AMF is triggered by the AAA S.

8. The system of claim 6, wherein the first AMF is selected based on:
determining a presence of a slice context (“SliceAuthContext”) at the NSSAAF, wherein the “SliceAuthContext” comprises addresses of the first AMF and the second AMF;
checking the NSSAI associated with the network slice and a UE Identification (ID) received from an Authentication, Authorization, and Accounting-Server (AAA-S) upon determining that the NSSAAF includes the “SliceAuthContext”;
fetching the address of the first AMF from the “SliceAuthContext” based on the NS SAI and the UE ID; and
selecting the first AMF amongst the first AMF and the second AMF in response to fetching the address of the first AMF.

9. The system of claim 8, wherein the NSSAAF is further configured to:
determine an absence of a “SliceAuthContext” at the NSSAAF;
request an Unified Data Management (UDM) to share the addresses of the first AMF and the second AMF; and
select the first AMF from amongst the first AMF and the second AMF in response to receiving the addresses of the first AMF and the second AMF from the UDM.

10. The system of claim 6, wherein the first AMF is a 3rd generation partnership project (3GPP) AMF and the second AMF is non-3GPP N3GPP AMF.
